(19) United States
(12) Patent Application Publication
(10) Pub. No.: US 2024/0202383 A1
(43) Pub. Date: Jun. 20, 2024

(54) ASSEMBLY PACKING IN 3D PRINTING

(71) Applicant: Hewlett-Packard Development Company, L.P., Spring, TX (US)

(72) Inventors: Guiu Tio Medina, Sant Cugat del Valles (ES); Sergio Gonzalez Martin, Sant Cugat del Valles (ES); Jordi Roca Vila, Sant Cugat del Valles (ES)

(21) Appl. No.: 18/287,854

(22) PCT Filed: Apr. 26, 2021
(86) PCT No.: PCT/US2021/029190

§ 371 Date: Oct. 20, 2023

(51) Int. Cl. G06F 30/17; B29C 64/386; B33Y 50/00

(52) U.S. Cl. CPC G06F 30/17; B29C 64/386; B33Y 50/00

(57) ABSTRACT

Information on assembly components to be printed by a three dimensional (3D) printer is accessed. Different assembly arrangements are determined based on the information to optimise three dimensional (3D) nesting.

### BACKGROUND

Additive manufacturing systems may be used to produce three-dimensional objects. Some additive manufacturing machines are commonly referred to as “3D printers.” 3D printers and other additive manufacturing machines make it possible to convert model data relating to computer aided design (CAD) models or other digital representations into a physical object. The model data may, in some examples, be processed into slices each defining part of a layer or layer of build material to be formed into the object. Build material may comprise any suitable form of build material, for example fibres, granules or powders. The build material can include thermoplastic materials, ceramic material and metallic material. Build packing, or 3D nesting, is a part of the workflow of additive manufacturing and includes packing the printed, or built, objects into a build volume of an additive manufacturing machine.

### BRIEF DESCRIPTION OF THE DRAWINGS

FIG. 1 shows an example method for optimising 3D nesting of assemblies in additive manufacturing.

FIG. 2 shows an example method for receiving data concerning a printable assembly and its component parts.

FIG. 3 shows an example method for generating assembly arrangement candidates that each represent a functional assembly of components.

FIG. 4 shows schematically a number of different example assembly arrangements.

FIG. 5 shows an example packing process in which 3D nesting may be optimised using assembly arrangements.

FIG. 6 shows an example controller to optimise 3D nesting of assemblies.

FIG. 7 shows an example of a computer readable medium comprising instructions to optimise 3D nesting of assemblies.

### DETAILED DESCRIPTION

Many additive manufacturing processes have in common that printed products are to be packed into a finite number of printable boxes, or containers, having a fixed volume which is sometimes referred to as a build volume. Additive manufacturing processes may be bound by the dimensions of a build volume. During the data preparation process for additive manufacturing, many machines employ a build preparation process to try to pack as many printed objects of a given volume as possible into the build volume of an additive manufacturing machine.

3D nesting may be employed to maximise space inside a build volume to take into consideration its full capacity and to maximise output of the machine. 3D nesting may be employed to manually or automatically translate, sort, orient and arrange 3D models or files representing a collection of printable objects. The object representations can be manipulated within a defined area representing a build volume to maximise the number of objects able to fit into the build volume. Inefficient use of nesting can lead to material wastage, reduced productivity/throughput and therefore increased manufacturing costs.

To maximise space inside a build volume, build parts that are intended to be assembled together as a final product are often printed individually. Sorting and orienting individual objects of the collection of printable objects provides greater design freedom to minimise empty space inside the build volume and space utilisation during the 3D nesting preparation stage can be improved. A high degree of build volume utilisation can increase productivity and cost effectiveness of additive manufacturing processes.

Build packing processes often do not consider the cost of the manual work to assemble the individual, or component, parts of an object after build volume utilisation has been realised. Accordingly, a post-processing action is often carried out to combine the individual, or component, parts to build an end product known as an assembly or, in the case of a product comprising moving parts, a functional assembly. Such post-processing impacts the additive manufacturing process because productivity or throughput can be reduced and the overall manufacturing cost may be increased. This may be particularly true for products having multiple component parts.

The described method balances packing density and post-processing in an additive manufacturing system. There may be a trade-off between packing density and the post-processing of assembling component parts. In some cases, it may be possible to avoid the post-processing of assembling component parts by trading some of the packing density in the build packing process.

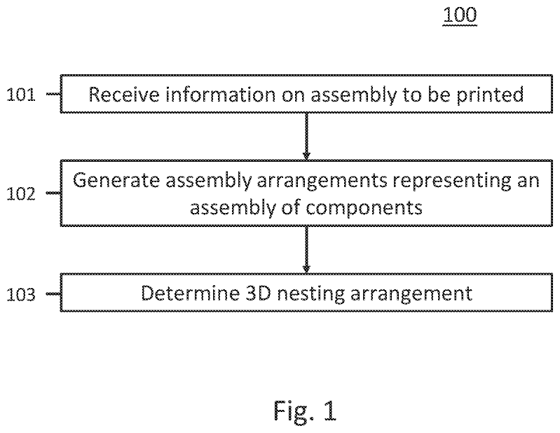

FIG. 1 shows an example method 100 for determining an optimised 3D nesting arrangement for a printable functional assembly. Data concerning a printable assembly including its component parts is received at 101. Based on this data, at 102 digital assembly arrangements representing the end assembly product may be generated. Representations termed assembly arrangements may be generated by disposing, or orienting, the assembled component parts differently to create different patterns from the parts. Assembly arrangements represent a suitable and printable assembled configuration of the component parts that may be arrived at by modifying an overall footprint of the assembly using the data received at 101. A nesting arrangement is determined at 103 using the generated assembly arrangements. A nesting arrangement determined at 103 may comprise an arrangement that optimises space within the build volume. A non-optimised nesting arrangement may also be determined at 103. A method may comprise: receiving component information representing components to be printed by a three dimensional (3D) printer; generating assembly arrangements representing a functional assembly of the components with a bounding box; and determining a 3D nesting arrangement using the generated assembly arrangements.

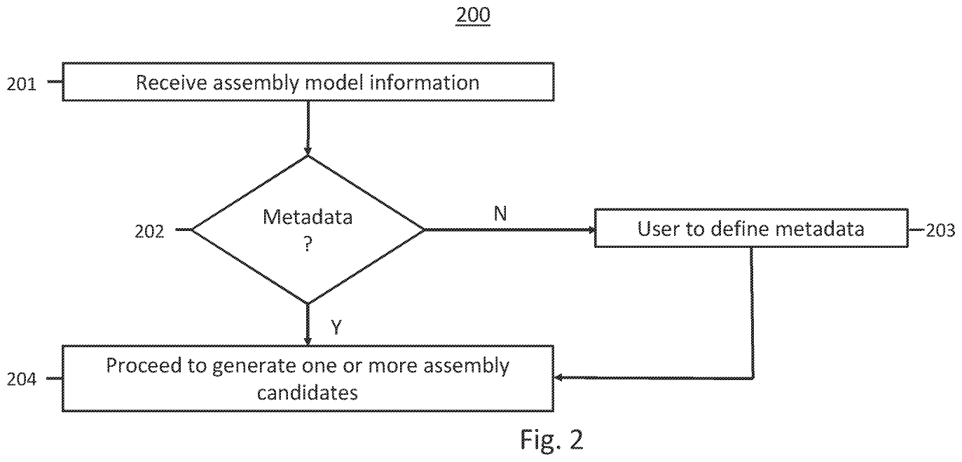

FIG. 2 illustrates an example method 200 for receiving data concerning a printable assembly including data on its component parts. At 201, assembly model information is received. Assembly model information, or data, may comprise, for example, data on the number of parts needed to create the assembly, data on the external and/or internal form of each component part (e.g. shape, volume, area, etc.), the sweeping volume of each component part, and/or data concerning the relationship (positional, relative movement or otherwise) between parts of the assembly. The sweeping volume of an assembly part is formed by all points in space which are covered by positions of the part during a movement that the part is able to make as part of the printed and assembled product. In other words, the sweeping volume may be considered to be an area through which the assembled part may move or rotate. Component parts may be printed to provide connection points between parts such as e.g. hinges to allow for relative movement between connecting parts as well as for multiple different orientations based on a degree of movement, or opening, between respective connection points. Data concerning the printable assembly and its component parts may reflect the connection between parts and the degree of relative movement allowed by virtue of the connection e.g. hinge, socket and ball etc.

Data at 201 may be received from a storage medium comprising assembly model information for one or a plurality of assemblies. In another example, the data may be received by virtue of a user inputting the data via e.g. a graphical user interface (GUI). In the case that it is determined at 202 that certain metadata is not defined at 201, a user of the additive manufacturing system may define metadata at 203. Metadata in this instance may include, for example: data so as to define parts of the assembly that are considered to be fixed i.e. should not be deemed to be movable in a later stage of the method when different overall footprints of the assembly are investigated; data defining parts of the assembly that are considered to be movable i.e. parts that are deemed to be able to be moved to create a different overall footprint of the assembly; and/or data defining positional relationships between parts of the final assembly i.e. which part combines with another to create the assembled product. Block 203 provides a user with an opportunity to provide data that may be useful for defining different possible arrangements of the component parts to create an assembly footprint.

Assembly model information, including metadata, may comprise all data for the process to be able to access assembly and/or component data in order to determine component positions as part of a final printable assembly, component movement relative to another component, and/or component/assembly limitations that are a consequence of, for example, the component's shape, size and movability. As will be explained below, the assembly model information is usable to determine a number of different component dispositions so as to modify the overall footprint of the digital representation of the assembled product. Different dispositions may be generated based on information concerning component relationships and/or component movability.

After assembly model information and metadata has been received, the process may proceed at 204 to generate at least one assembly arrangement candidate.

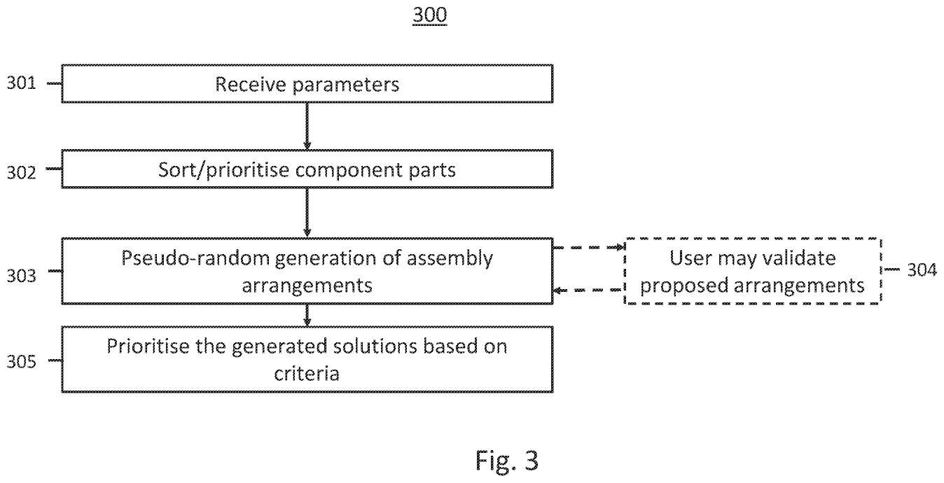

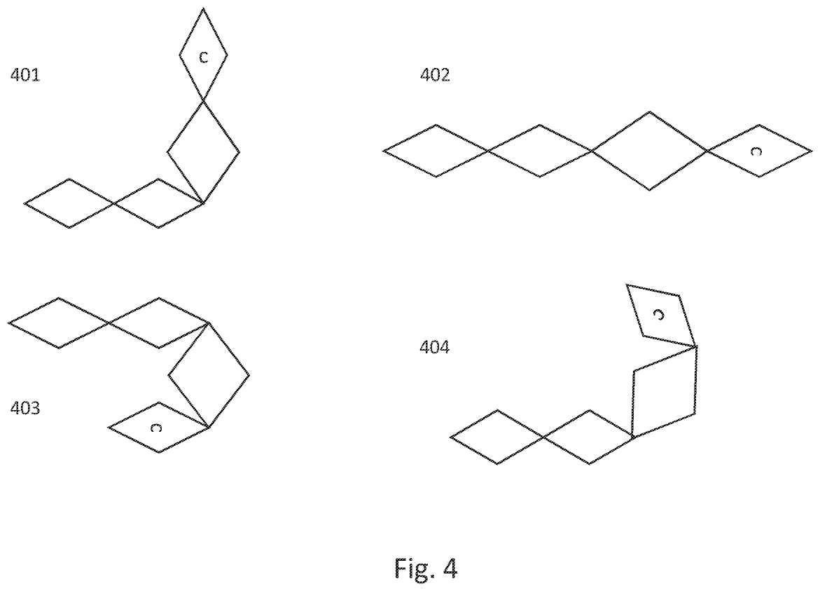

FIG. 3 illustrates an example method 300 for generating assembly arrangement candidates that each represent a functional assembly of components. Arrangement candidates represent an overall footprint of the assembled product while using different dispositions for movable component parts. The change in disposition of movable parts of the assembly creates different patterns in which parts are arranged in relation to each other. FIG. 4 illustrates different dispositions/arrangements of component parts and illustrates how variation in part orientation may create different overall footprints for an assembly.

At 301 of FIG. 3 a number of parameters used for assembly arrangement generation may be received by being accessed or specified. The parameters may be pre-stored parameters and accessed from a storage medium, or they may be input by a user using e.g. a GUI. Parameters used for generating an assembly arrangement can include, for example: criteria that specify a condition, or conditions, under which the candidate assembly arrangement generation process is terminated; an integer that specifies the number of assembly arrangements to be evaluated in the optimisation of 3D nesting; angle steps defining an angle by which movable parts may be rotated in the generation of candidate assembly arrangements; a number of angle steps by which all or individual parts may be moved to create the candidate arrangements; restrictions concerning the orientations and/or positions that parts of the assembly may or may not be disposed in; and/or execution time for generating candidates etc. Parameters received or specified at 301 may further include those relating to 3D nesting optimisation such as: process iteration time before termination; number of iterations before termination; target Z height for the nest; target nest quality; and/or target packing density etc. No-build zones may also be defined as a parameter. No build zones are defined spaces or gaps within the build volume, or nest, within which manufacturing should not take place. No-build zones may provide a minimum gap between the manufactured objects to prevent fusing of the objects.

Parameters used for generating a candidate assembly arrangement may be any parameter that can be used to define or change a number of candidate arrangements, a disposition of an assembly part, and a footprint of the assembly arrangement.

In the present example, parameters relating to assembly arrangements and 3D nesting optimisation may be entered or accessed separately to data at 201, but all process data may be accessed or received in a single data retrieval process e.g. 101 or 201.

Parts of the assembly may be considered at 302 and movable parts, for example, may be sorted according to at least one component-specific characteristic that is accessed or defined as part of 101, 201 and/or 203 above. For example, different dispositions may be generated based on assembly component volumes. In one example it may be the case that the method prioritises, by virtue of a stored instruction or user input, a number of components having the largest sweeping volume. Assembly patterns may therefore be generated by modifying the assembly footprint based predominantly or exclusively on different dispositions of parts having the greatest sweeping volume. Accordingly, and according to the provided example, more combinations for the movable parts having the greatest sweeping volume will be evaluated compared to movable parts with a relatively smaller sweeping volume. A characteristic of a component may be used to prioritise at least one component and to move the at least one component to modify a footprint of the assembly arrangement. As discussed, it may be the case that different assembly arrangements are generated by generating different dispositions for components having a largest sweeping volume. Prioritising component parts based on a characteristic of the component allows the process to reduce computational processing in generating practical modifications to the assembly footprint because not all parts will be considered when generating different assembly arrangements. Compared to a brute force approach where all possible components and orientations are evaluated, prioritisation of parts efficiently reduces the solution space because the most feasible or practical components are identified and used for part orientation/rotation to generate candidate arrangements.

Generation of assembly arrangements takes place at 303. Pseudo-random generation is used to generate different assembly arrangements. Pseudo-random generation may be used to generate different assembly arrangements by moving some or all of the prioritised movable parts according to a range of possible positions in view of parameters received at 301. Different combinations of movable parts and different positions for each part may be evaluated at 303 to provide a number of assembly arrangement candidates which may be used later to optimise 3D nesting. FIG. 4 provides four examples 401 to 404 of printable functional assemblies with component parts arranged in different dispositions thereby creating different assembly footprints. It is illustrated that component parts of the assembly are placed into different dispositions to generate different overall footprints of the assembly. At 304 of FIG. 3, a user may review at least some of the candidate assemblies to determine whether assemblies are valid for e.g. its intended purpose or for quality assurance. For example, a user may be aware of a restriction for an assembly part in terms of its disposition and it is therefore preferable that a part is to be printed with a certain orientation to avoid e.g. stair stepping.

Stair stepping in 3D printing can affect surface quality of a printed product and occurs when seam lines between layers of build material and excess material is left as residue on the printed object. The surface appearance of the printed object may be negatively affected. Stair stepping can be reduced by orienting parts in such a way that the number of surface normals that are perpendicular or parallel to a build direction (layer or printing orientation) is maximised. If a certain component part is to be oriented in a particular manner to avoid e.g. stair stepping and therefore enhance the overall appearance of the printed object, then a user may discard a generated assembly candidate. Additionally, a user may create and add an arrangement that is to be included as part of the generated assembly arrangements.

FIG. 3 is illustrated with block 304 included. However, 304 which relates to user validation to verify, discard, or add assembly candidates may equally not be included. Inclusion of validation such as in block 304 allows a user to verify assembly candidates and to ensure that each candidate assembly is able to fulfil its intended purpose and result in a quality final product.

Generated assemblies are analysed at 305 using criteria to determine whether they should be used to optimise 3D nesting. A bounding box may be used to determine whether the generated assembly arrangements are to be used to determine an optimised 3D nesting arrangement. A bounding box, for example, may specify the minimum and/or maximum size of a box within which individual assemblies should be contained. A bounding box may have X, Y and Z coordinates that should encompass the entirety of a generated assembly arrangement. Bounding boxes may be expressed in a variety of ways and some examples include: minimum volume bounding box, bounding box with maximum side (X, Y or Z axis), bounding box with minimum side (X, Y or Z axis), bounding box with maximum isotropy; and/or a bounding box with isotropy in two dimensions (e.g. XY, YZ, or XZ) etc. Accordingly, and as will be understood, bounding boxes may be used as a tool to express certain criteria, or limitations, with the generated assembly representations being contained within the defined criteria or limitations. A number of different bounding boxes may be defined and used at 303 to set targets or goals relating to the footprint of the generated assembly arrangements. A list of candidate arrangements can be generated according to which candidates fall within the different bounding boxes. The generated lists may indicate which arrangements best fit within the bounding boxes with, for example, those that most comfortably fit within the bounding box toward the top of the list and those that are a tight, or complex, fit within the bounding box being toward the bottom of the list. At 305, generated candidate assemblies are sorted and prioritised using e.g. any suitable combination of bounding boxes and/or “best fit” in bounding boxes. Criteria for sorting and prioritising the candidate assembles may be based on stored instructions or instructions received from a user. The sorted and prioritised candidates provide a set of candidate assemblies that can be utilised to optimise 3D nesting to fit as many digital assembly representations into the representation of the build volume of the additive manufacturing machine i.e. determine the greatest packing density in the build preparation process.

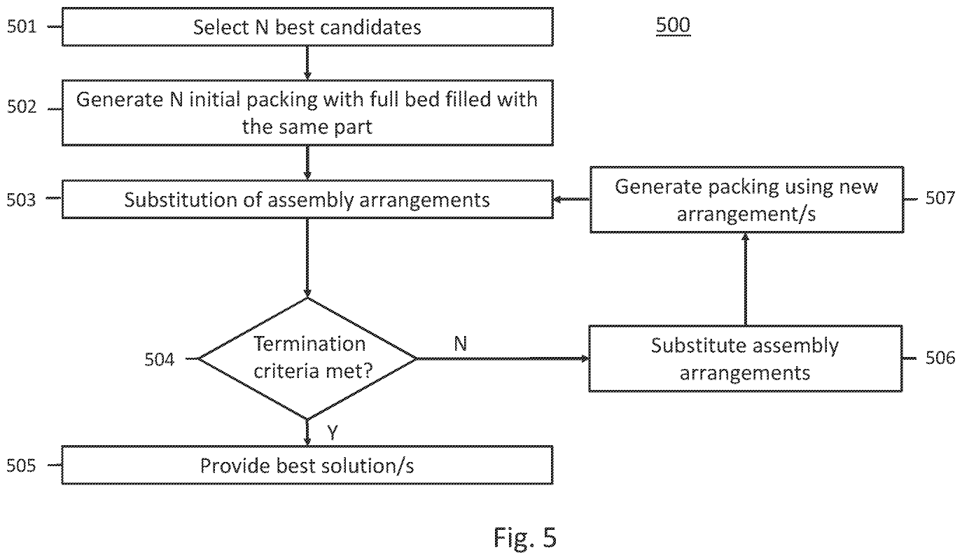

FIG. 5 illustrates one example of a packing process in which 3D nesting may be optimised using candidate assembly arrangements. Processes that may be used in the packing process include any computational metaheuristic optimisation. Example processes may include: ant colonies optimisation; genetic algorithm; biased-randomised iterative localised search; and/or Greedy Randomized Adaptive Search Procedure (GRASP).

The example process of FIG. 5 is illustrated using GRASP to optimise 3D nesting of assemblies.

The example packing process of FIG. 5 is focused on finding an optimal, or near optimal, solution to maximise packing density for printable functional assemblies. As discussed, packing density for assemblies may not be as great compared to nesting the parts individually but nesting assembles, rather than individual parts, is able to remove the post-processing of manual or automatic component assembly. The described processes may lead to an efficient manufacturing process because packing density in nesting is traded against costly post-processing.

At 501, an integer number, N, of valid arrangements, or arrangement candidates is selected. Data concerning candidate arrangements is evaluated and used to prepare a sub set of arrangement candidates considered to be best candidates that might help to realise a high packing density for a plurality of assemblies. N arrangement candidates may be generated based on any suitable criteria such as, for example: arrangements that are best considered to be encompassed by respective bounding boxes; arrangements validated by a particular bounding box; and/or overall footprint, or volume, of arrangements. Assembly arrangements may be validated if the footprint of the assembly does not exceed parameters that define a bounding box. In another example, at 501 selection of candidate arrangements may be based on e.g. a number of layers required to manufacture an assembly/component parts to increase speed of assembly/component manufacture, or assembly arrangements having components in a specific orientation to increase strength or aesthetics in the manufactured assembly.

At 502, the representation of the build volume, or nest, is filled with a selected arrangement to represent a 3D nest. Again, the arrangement selected to initially fill the nest may be selected based on a number of factors similar, or the same, as those described in relation to 501. An initial packing solution, or 3D nesting arrangement, is provided at 502 and a nest quality metric such as e.g. packing density or stack height is stored in association with the solution for comparison against other solutions generated in the process of FIG. 5. Comparison of the generated solutions allows for an optimal, or near optimal, assembly packing solution to be determined by generating solutions that that try to realise the best nest quality. The best nest quality may be determined by using the same assembly arrangement (assembly footprint) for all of the assemblies able to fit into the nest representation, but it may equally be realised by using a combination of different assembly arrangements in the nest. The target of the packing process is to find the best assembly arrangement or combination of assembly arrangements to maximise the build volume and fit as many assemblies as possible into the build volume of the machine. Determining an optimised 3D nesting arrangement may comprise generating a plurality of nesting arrangements using the generated assembly arrangements and comparing a nest quality of the nesting arrangements.

Substitution of assemblies within the build volume begins at 503. In this example, biased-randomised substitution is used to substitute at least one assembly located within the initial solution. That is, an arrangement within the initial solution is randomly located and selected to be replaced by a different assembly arrangement (i.e. different footprint) from the N valid arrangements of 501. For example, at least one arrangement that was considered to best fit a minimum volume bounding box may be selected to be replaced by an arrangement that was considered to best fit a bounding box with minimum side. An assembly or assemblies within a previous nest solution may be randomly located in the solution and selected to be replaced by at least one different arrangements from the N valid arrangements. Determining the optimised 3D nesting arrangement comprises substituting an assembly arrangement of a previously generated 3D nesting arrangement with a different assembly arrangement to generate a further 3D nesting arrangement. Generation of a 3D nesting arrangement may be based on at least one of the generated assembly arrangements or a combination of the generated assembly arrangements. The purpose of the biased-randomised substitution of assemblies is to evaluate the use of different arrangements and combinations of arrangements (footprints) to generate a nest solution that tries to realise the best nest quality e.g. greater packing density. The solution space is reduced by obtaining N valid arrangements at 501 because e.g. most feasible, or practical arrangements may be included as one of the N arrangements at 501. In other words, the number of generated arrangements may be limited to a subset of arrangements that are considered most likely to provide the best nest quality.

Solutions generated at 503 may be stored alongside their respective nest quality metric(s) to allow each of the solutions to be compared to previous and future solutions. For each solution, data concerning the nest and arrangements used is stored alongside the nest quality metric.

Termination criteria of the packing process is evaluated at 504. In some examples, termination criteria may be accessed or received at 101, 201 or 301. Termination criteria may define conditions or standards under which process 500 may be terminated and nesting solution generation and evaluation is stopped. Some examples of termination criteria are provided above in relation to 301. Process 500 may, for example, be terminated after a certain period of time, a given number of iterations, a given number of arrangement combinations etc. Any reasonable criteria may be set to limit the number of solutions generated and evaluated and therefore terminate process 500.

If it is determined at 504 that the termination criteria has not been met then the process 500 proceeds to 506. At 506, it is determined e.g. which arrangements are least used in the best solutions found so far and the least used arrangements may be replaced by at least one different arrangement from the N valid arrangements of 501. Any other reasonable metric or criteria may be used to determine which arrangement should be replaced or used when trying to beat a nest quality metric of a stored solution.

After a different assembly arrangement has been determined at 506, a different solution is generated at 507 based on the arrangement selected at 506. In other words, a new nest is generated using the newly selected arrangement and the full bed is packed with the same arrangement. The nesting arrangement and associated nest quality is stored for comparison against other nesting arrangements. In some examples, it may be the case that nest solutions of 502 and 507 are not generated using the same arrangements and they may, instead, use a selection of arrangements.

Process 500 continues through 503 to 507 using at the N valid arrangements and e.g. least used arrangements in an attempt to generate a solution that provides the best nest quality.

If at 504, it is determined that termination criteria is met, the process proceeds to 505 and nest quality of stored solutions are analysed to identify solutions that have the best nest quality. These solutions may simply be ranked in order from best to worst or a list, or visual representations may be generated and made available to a user. Best solutions need not be analysed at 505 and nest quality of solutions may be compared as each new solution is generated. A list of best solutions may be continually updated through process 500. 505 may simply make available a list of best solutions for manual or automatic determination of which solution should be used for 3D nesting of the functional assembly during the manufacturing process.

The examples described above may be used to determine an optimised 3D nesting arrangement that may be used to generate printer data and to 3D print an assembly of components.

The examples described above remove the need for the post-processing action of building an assembly from a number of printed individual parts because component parts are printed as a functional assembly i.e. printed as connected and movable parts.

Printing assembly component parts individually may provide greater freedom for nesting and may achieve greater packing density. Printing functional assemblies may not provide as much freedom to realise the highest packing density but the examples described above may allow for optimised packing density of assemblies while removing the need assembling individual parts in post-processing.

The described examples trade some of the packing density in the build packing process by printing the product as a functional assembly but allows for removal of manual, or automatic, part assembly after the products have been printed.

The packing density of a job is optimised by investigating different patterns of the assembly parts to provide different overall footprints of the assembly and using at least one pattern to efficiently fill the build volume with as many functional assemblies as possible.

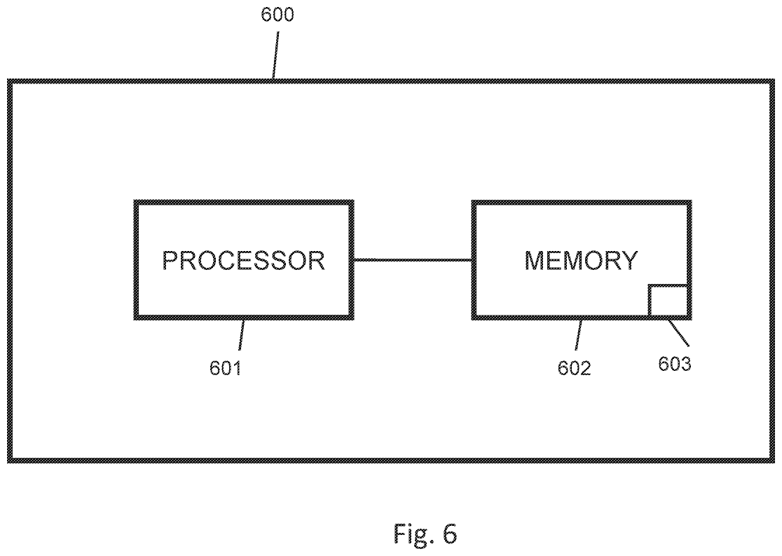

FIG. 6 shows an example of a controller 600 to optimise 3D nesting of printable assemblies. The controller 600 comprises a processor 601 and a memory 602. Stored within the memory 602 are instructions 603 for carrying out a method that may be used to optimise 3D nesting of manufacturable assemblies, in accordance with any of the examples described above. In one example, the controller 600 may be part of a computer running the instructions 603. In another example, the controller 600 may be part of a 3D printer which may be used to run the instructions 603 to find a solution for nesting assemblies within a build volume of 3D printer. In a further example, there is provided an apparatus comprising a controller to access information on assembly components to be printed by a three-dimensional (3D) printer, and to determine, based on the information, different assembly arrangements to optimise three dimensional (3D) nesting. In one example, the controller may generate different dispositions of assembly components to modify a footprint of the assembly arrangements. Different dispositions generated by the controller may be generated based on information concerning component relationships and/or component movability. Different dispositions generated by the controller may, in an example, be generated based on assembly component volumes. The controller may generate different assembly arrangements by generating, according to an example, different dispositions for components having a largest sweeping volume. In one example, the controller may validate an assembly arrangement if the footprint of the assembly does not exceed parameters that define a bounding box.

Reference to printer, or 3D printer, in the above description may be understood to apply equally to other types of additive manufacturing system.

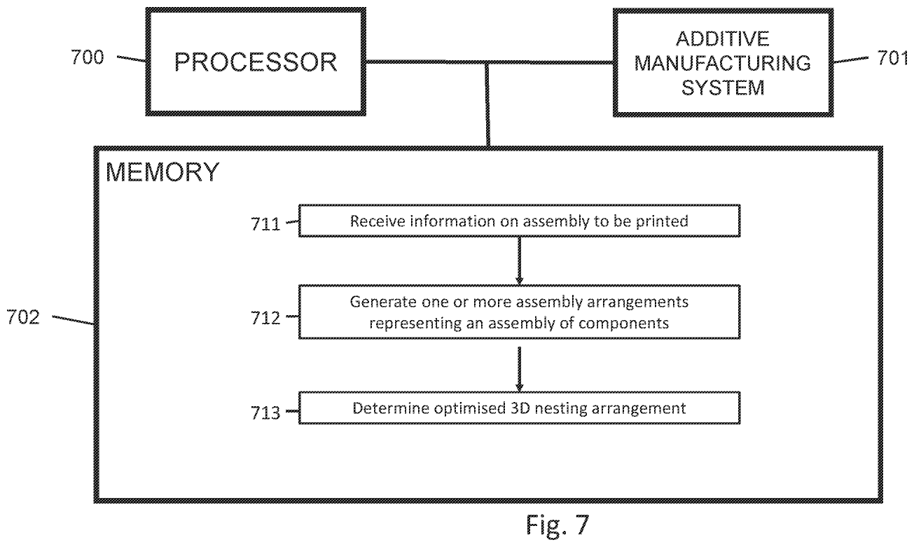

FIG. 7 shows a memory 702, which is an example of a computer readable medium storing instructions 711 to 713 that, when executed by a processor 700 communicably coupled to an additive manufacturing system 701 causes the processor 700 to receive data for 3D nesting of assemblies, generate assembly arrangements and determine a 3D nesting arrangement that may be used to optimise 3D nesting. This process may be performed in accordance with any of the examples described above. The instructions may also enable generation of printer data based on an assembly components and 3D nesting optimisation. The printer data may be provided to a 3D printer which can print 3D objects based on the printer data. In one example, a computer-readable medium may comprise instructions that, when executed by a computer, cause the computer to obtain component information of a printable assembly and determine, based on the information, different dispositions of the assembled components to be used in three dimensional (3D) nesting. The computer readable medium 702 may be any form of storage device capable of storing executable instructions, such as a non-transient computer readable medium, for example Random Access Memory (RAM), Electrically-Erasable Programmable Read-Only Memory (EEPROM), a storage drive, an optical disc, or the like.

1. A method comprising:
receiving component information representing components to be printed by a three dimensional (3D) printer;
generating assembly arrangements representing a functional assembly of the components within a bounding box; and
determining a 3D nesting arrangement using the generated assembly arrangements.

2. The method of claim 1, wherein determining the 3D nesting arrangement comprises generating a plurality of nesting arrangements using the generated assembly arrangements and comparing a nest quality of the nesting arrangements.

3. The method of claim 1, wherein pseudo-random generation is used to generate different assembly arrangements.

4. The method of claim 3, wherein a characteristic of a component is used to prioritise at least one component and to move the at least one component to modify a footprint of the assembly arrangement.

5. The method of claim 1, wherein a bounding box is used to determine whether the generated assembly arrangements are to be used to determine the optimised 3D nesting arrangement.

6. The method of claim 1, further comprising generating a 3D nesting arrangement based on at least one of the generated assembly arrangements or a combination of the generated assembly arrangements.

7. The method of claim 6, wherein determining the 3D nesting arrangement comprises substituting an assembly arrangement of a previously generated nesting arrangement with a different assembly arrangement to generate a further nesting arrangement.

8. The method of claim 1 wherein the 3D nesting arrangement is used to generate printer data and to 3D print an assembly of components.

9. An apparatus comprising: a controller to: access information on assembly components to be printed by a three dimensional (3D) printer; and determine, based on the information, different assembly arrangements to optimise three dimensional (3D) nesting.

10. The apparatus of claim 9, wherein the controller generates different dispositions of assembly components to modify a footprint of the assembly arrangements.

11. The apparatus of claim 10, wherein the different dispositions are generated based on information concerning component relationships and/or component movability.

12. The apparatus of claim 10, wherein the controller is to generate different dispositions based on assembly component volumes.

13. The apparatus of claim 9 or 10, wherein the controller is to generate different assembly arrangements by generating different dispositions for components having a largest sweeping volume.

14. The apparatus of claim 9, wherein the controller is to validate an assembly arrangement if the footprint of the assembly arrangement does not exceed parameters that define a bounding box.

15. A computer-readable medium comprising instructions that, when executed by a computer, cause the computer to: obtain component information of a printable assembly and determine, based on the information, different dispositions of the assembled components to be used in three dimensional (3D) nesting.
